(19) United States
(12) Patent Application Publication
(10) Pub. No.: US 2020/0122366 A1
(43) Pub. Date: Apr. 23, 2020

(54) SYSTEM AND METHOD FOR MAKING MOLDED ARTICLES

(71) Applicant: Meiban Global Pte Ltd., Singapore (SG)

(72) Inventors: Su Min Goh, Singapore (SG); Soon Teck Lim, Singapore (SG); Chye Huat Choo, Singapore (SG)

(73) Assignee: Meiban Global Pte Ltd., Singapore (SG)

(21) Appl. No.: 16/654,193

(22) Filed: Oct. 16, 2019

Related U.S. Application Data
(60) Provisional application No. 62/747,256, filed on Oct. 18, 2018.

(51) Int. Cl. B29C 45/00; B29C 45/14; B29C 45/76

(52) U.S. Cl. CPC B29C 45/0046; B29C 45/14065; B29C 45/0053; B29L 2031/3418; B29C 45/14688; B29K 2713/00; B29C 45/76

(57) ABSTRACT

A system and method for automating the making of molded articles formed from a substrate and a fabric material, wherein the fabric material is positioned over a mold surface and a substrate material is injected between the fabric material and the mold surface such that the substrate material hardens and bonds with the fabric material forming the molded article.

The present application claims benefit to and incorporates in its entirety by reference the subject matter contained in U.S. provisional patent application No. 62/747,256 filed on Oct. 18, 2018.

### BACKGROUND OF THE INVENTION

The subject invention is directed to a system and method for making articles and more particularly, to a system and method for molding articles from plastic having a decorative effect of fabric.

Systems have been developed that are used to obtain a molded article having a decorative printing along the surface of the article. One such system utilizes an injection molding process whereby the mold cavity is covered with a cloth fabric in a tense state so that the printed surface of the cloth is disposed opposed to the injection nozzle. A hot melt resin is injected into the mold cavity and cooled and setting the molded article with a cloth applied on the surface. After the molded article is taken out of the mold the cloth is removed leaving the molded article with the appearance of the printing of the cloth on the surface.

Systems have also been developed whereby a decorative film is arranged to cover a recessed part using a mold. The decorative film is softened in the annular cavity of a mold by pressure and heat created by the molten resin being injected into the mold cavity thereby integrating the resin with the film to form a single piece having resin formed on a first surface and a decorative film layer on a second surface.

While such system can be utilized to make plastic molded parts having a decorative outer surface or fabric or a film covered surface, such processes operate to form parts having continuous solid molded surfaces. While such parts have many uses, they are often not acceptable for use where parts having openings or apertures are desired. For example, articles or use with acoustical devices, such as speaker covers, where a plurality of openings are required to provide proper acoustical effects. While plastic molded articles having decorative surfaces have been developed, articles formed incorporating fabric or films along the surface of a molded article require a second operation to be performed on the article after it has been removed from the mold to create holes along the surface of the molded article. This additional separate step is both time consuming and increases the manufacturing cost of the article.

Accordingly, it would be desirable to have a system and method whereby articles are formed using a plastic molding process such that the plastic article formed has a fabric outer surface and one or more holes placed along one or more predefined areas along and extending through the surface of the molded article.

### SUMMARY OF THE INVENTION

The subject invention is a molding system for creating a molded article having a substrate and a fabric material positioned over the substrate, the molding system comprises a first component having a cavity slider with a contour portion; a second component having a core insert with a mold surface; wherein the molding system operates such that the core insert is moved into molding position with the contour portion and fabric material is positioned between the contour portion and the mold surface; and wherein substrate material is injected along the mold surface between the mold surface and the fabric material to form a substrate for the fabric material.

In a preferred embodiment of the invention the second component further includes an internal slider that operates to press against the fabric material against the contour portion such that one or more openings are formed in the substrate.

In another preferred embodiment the second component includes a fabric positioning and maintaining system for maintaining the fabric material in place while substrate material is being injected along the mold surface.

In another preferred embodiment of the invention the second component includes one or more locator pins and core locator blocks and the first component includes cavity locator blocks, wherein the one or more locator pins, core locator blocks and the cavity locator blocks cooperate to direct and maintain the fabric material in place while substrate material is being injected along the mold surface.

In another preferred embodiment of the invention the molding system further includes a cutting tool for cutting the fabric material.

In another preferred embodiment of the invention, the molding system for creating a molded article having a substrate and fabric material positioned over the substrate, the molding system comprises a first component having a clamp plate supporting a cavity slider, wherein the cavity slider has a contour portion and wherein the cavity slider has a closed position and an open position, such that the cavity slider is in the closed position when attaching the fabric material to the substrate forming a molded article and is in the open position when the molded article is removed from the molded component; a second component has a bottom clamp plate for supporting a core insert, the core insert has a mold surface and an internal slider that operates to move into and out of engagement with the mold surface; and an injector and an injector channel for injecting and directing substrate material along the mold surface; wherein the first component and the second component has a first position such that the first component and the second component are separated for receiving fabric material and has a second position such that the fabric material is positioned between the contour portion and the mold surface; and wherein substrate material is injected such that the substrate material travels along the mold surface between the mold surface and the fabric material to form a molded article having a substrate bonded to the fabric material.

In a preferred embodiment the second component further includes an internal slider that operates to moves to press the fabric material against the contour portion such that one or more openings are formed in the substrate.

In a preferred embodiment of the invention the second component includes a fabric positioning and maintaining system for maintaining the fabric material in place while substrate material is being injected along the mold surface.

In a preferred embodiment of the invention the second component includes one or more locator pins and core locator blocks and the first component includes cavity locator blocks, wherein the one or more locator pins, core locator blocks and the cavity locator blocks cooperate to direct and maintain the fabric material in place while substrate material is being injected along the mold surface.

In a preferred embodiment of the invention the molding system further comprises a cutting tool for cutting the fabric material.

In a preferred embodiment of the invention the substrate material is a plastic material.

A preferred embodiment of the invention the molding system includes a master controller that operates to continuously monitor the state of the manufacturing process of final molded articles.

In a preferred embodiment of the invention that molding system includes a master controller that operate to generate control commands that are transmitted to various components of the molding system to regulate the operation of the various components.

In a preferred embodiment of the invention the master controller operates to direct the operation of multiple molding processes.

Another embodiment of the invention is a process for making a molded article having a fabric material bonded to a substrate comprising the steps of: moving fabric material into placement along a mold surface of a core insert of a second component; moving a first component having a cavity slider with a contour portion such that the fabric material is positioned between the contour portion and the mold surface; moving an internal slider of the second component such that it is pressed against the surface of the fabric material; injecting a substrate material such that it flows along the mold surface between the fabric material and the mold surface such that it forms a substrate bonded to the fabric material forming a prefinished molded article; removing the prefinished molded article from placement along the mold surface; cutting the fabric material at the ends of the fabric material to form a finished molded article.

The process of making a molded article whereby the internal slider operates to prevent substrate material to flow along a portion of the mold surface thereby creating openings in the substrate;

The process of making a molded article further comprising the step of folding the ends of the fabric material such that it covers the edge of the substrate.

Various other objects, advantages, and embodiments of the invention will be apparent from the following description, the accompanying drawings, and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a perspective illustration of a molded article formed by the system and method of the subject invention showing a substrate bonded to a fabric material and one or more opening through the substrate;

FIG. 2 is a perspective illustration showing another view of the molded article of FIG. 1;

FIG. 3 is a cut-away schematic side illustration identifying various components of a molding system to fabricate the molded article of FIG. 1 showing a first component and a second component and fabric material in position between the contour portion of the first component and the mold surface of the second component;

FIG. 4 is a schematic perspective illustration of the molding system of the subject invention showing a front clamp plate and a hydraulic system for activating a cavity slider;

FIG. 5 is a cut-away schematic side view of the molding system of FIG. 3 showing a front clamp plate, a cavity slider, a hydraulic system for activating the cavity slider, a core insert, an internal slider, a cam for activating the internal slider, an injector tube for injecting substrate material between the fabric material and the mold surface and the bottom clamp plate;

FIG. 6 is a schematic perspective illustration of the first component of the molding system of FIG. 3 showing a front cover plate, a cavity slider and a hydraulic system for activating the cavity slider, locator pins and cavity locator blocks that cooperate together to direct the fabric material across the mold surface of the core insert;

FIG. 7 is a schematic perspective illustration of the second component of the molding system of FIG. 3 showing the core insert, an internal slider for making holes in the molded article, and core locating blocks that cooperates with locator pins and cavity locator blocks for directing the fabric material and maintaining the fabric material in proper position for the molding process;

FIG. 8 is a schematic perspective cut-away illustration showing a second clamp plate, the internal slider and the cam for activating the internal slider;

FIG. 9 is a schematic perspective illustration showing the operation of a core locating block cooperating with a cavity locator block that cooperate together to press against the fabric material to hold the fabric material in place during the manufacturing process;

FIG. 10 is a cut-away schematic side illustration of the first component separated the second component of the molding system of FIG. 3 showing the first component having a cavity slider having a mold contour portion in its closed position for receiving a core insert having a mold surface and a fabric material in position to be placed along the mold surface;

FIG. 11 is a cut-away schematic side illustration showing the first component of the molding system in position with the second component of the molding system such that the core insert in position such that fabric material is positioned between the contour portion and the mold surface with the internal slider in its non-activated position;

FIG. 12 is a cut-away schematic side illustration of the molding system of the subject invention showing an internal slider in its activated position and an injector cylinder in position within an injector tube for injecting substrate material along the mold surface of the core insert;

FIG. 13 is a cut-away schematic side illustration showing the injector in its position within the injector tube and showing substrate material over the mold surface of the core insert for bonding with the fabric material;

FIG. 14 is a cut-away schematic side illustration showing the injector in its gating position and with the internal slider in its inactive position and the substrate material over the mold surface of the core insert;

FIG. 15 is a cut-away schematic side illustration showing the first component of the molding system separated from the second component and with a prefinished molded article positioned along the mold contour portion of the cavity slider;

FIG. 16 is a cut-away schematic side illustration showing the first component of the molding system separated from the second component showing the cavity slider in its open position for removing the prefinished molded article from position along the mold contour portion of the cavity slider of the first component;

FIG. 17 is a cut-away schematic side illustration showing the prefinished molded article being directed to a cutting station for cutting the fabric material;

FIG. 18 is a schematic side view of a prefinished molded article after having the fabric material cut at the cutting station and before the fabric material folded over a rib or flange of the substrate;

FIG. 19 is a schematic side view showing the prefinished article whereby the end of the fabric material is being folded around the edge of the substrate and secured in place;

FIG. 20 is a schematic side showing the final molded article whereby the end of the fabric material has been folded around the edge of the substrate and secured in place and extra fabric material having been is cut and removed from the final molded article;

FIG. 21 is a flow diagram showing the method for creating the molded article of the subject invention; and

FIG. 22 is a schematic illustration showing a master control system in communication with various components of the first component and the second component for controlling the operation of making final molded articles.

### DETAILED DESCRIPTION OF THE INVENTION

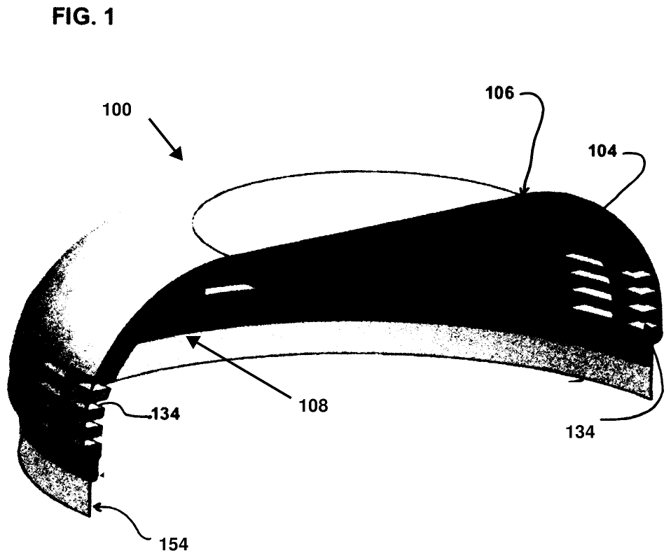

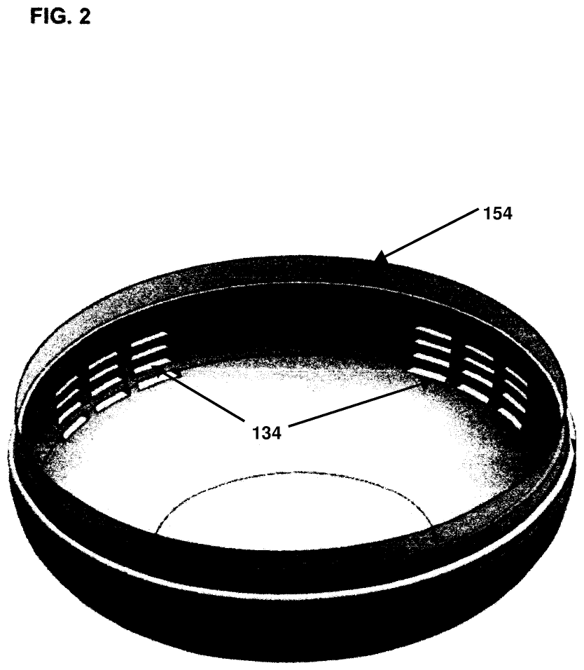

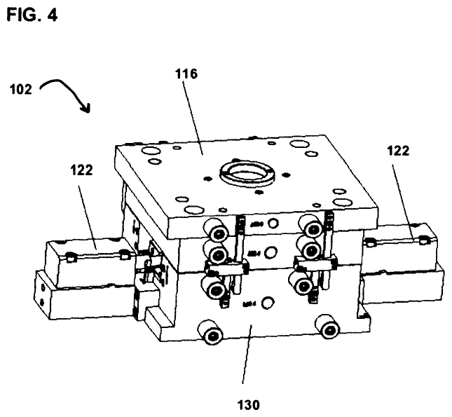

Referring to FIGS. 1 and 2, a final molded article 100 is shown created using a molding system 102 (FIG. 4) of the subject invention. As shown in FIG. 1, the final molded article 100 comprises a substrate 104 supporting a fabric material 106 positioned over the substrate 104. In a preferred embodiment of the invention, the fabric material 106 is cut and the cut end is folded over the edge 110 of the substrate 104 and secured in place, such as but not limited to a hot melt process. In another preferred embodiment, as shown in FIGS. 1 and 2, extending outwardly from the edge 110 of the substrate 108 is a rib or flange 154 formed from the substrate and fabric material 106 is adhered to the rib or flange 154 during the molding process so that the fabric material is not floppy and is in a fixed position which allows excess fabric material and the rib or flange to be cut off, such as by laser or a cutter, with greater precision.

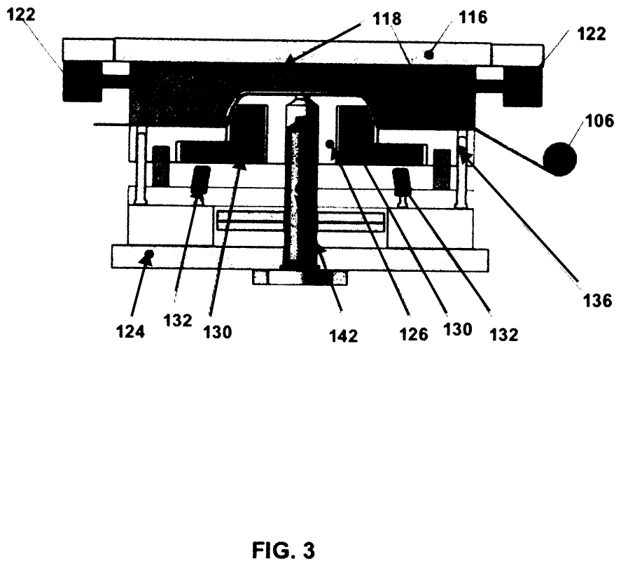

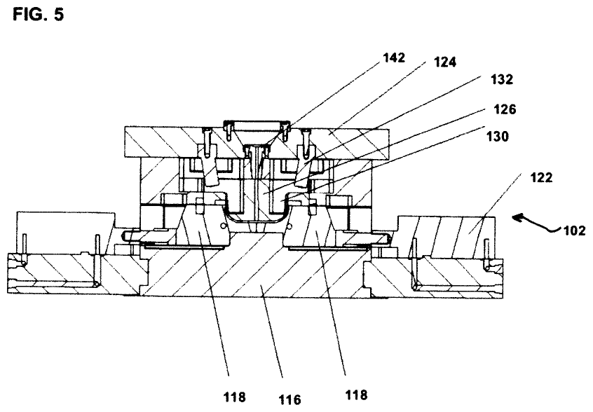

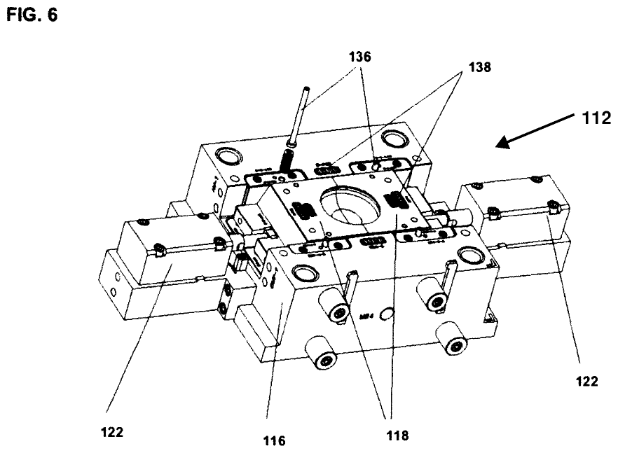

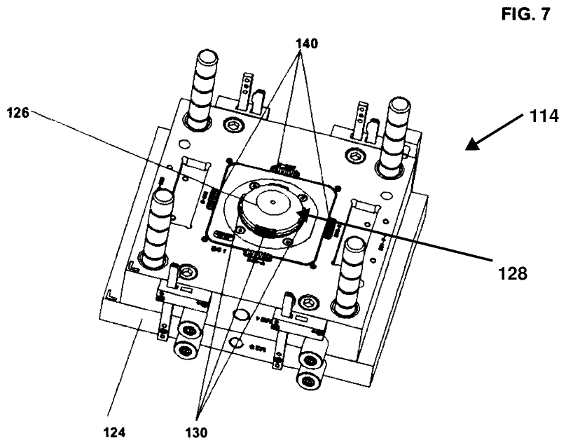

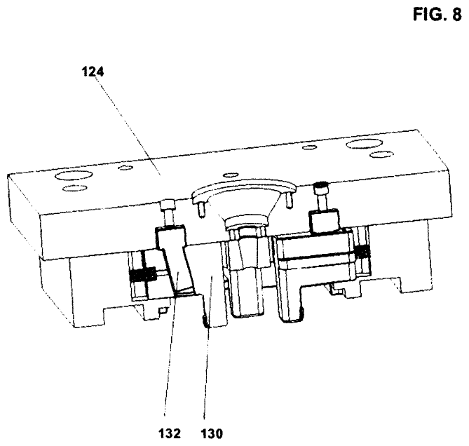

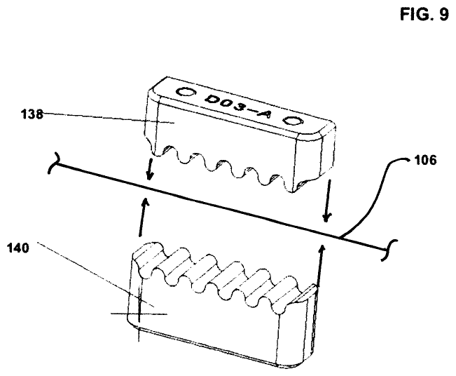

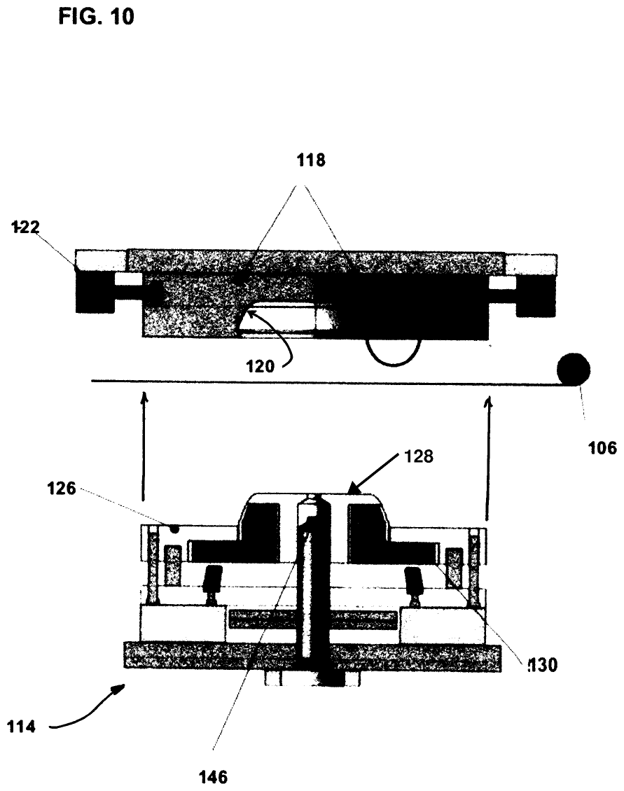

As shown in FIGS. 1-8, the molding system 102 of the subject invention comprises a first component 112 (FIG. 6) and a second component 114 (FIG. 7). The first component 112 includes a first clamp plate 116 for supporting a cavity slider 118 having a mold contour portion 120 (FIG. 10), which is preferably activated by a hydraulic system 122 (FIGS. 3-6 and 10). The second component 114 includes a second clamp plate 124, a core insert 126 having a mold surface 128 and an internal (inner) slider 130 that operates when moved into engagement by use of a cam 132 towards the mold surface 128 (FIGS. 7 and 10) to form one or more openings 134 (FIG. 1) at predefined locations through the substrate 104 of the molded article 100. As shown in FIG. 7, the internal slider 130 is positioned vertically away from the core insert 126 in order to keep from jumbling the fabric material 106 when the fabric material is positioned between the mold surface 128 of the core insert 126 of the second component 114 and the mold contour portion 120 of the cavity slider 118 of the first component 112. The second component 114 further includes a fabric positioning and maintain system having one or more locator pins 136 and one or more cavity locator blocks 138 and one or more core locator blocks 140 (FIGS. 6, 7, and 9) that cooperate together to direct the fabric material 106 and to keep the fabric material 106 in its proper position placement between the contour portion 120 of the cavity slider 118 and the mold surface 128 of the core insert 126.

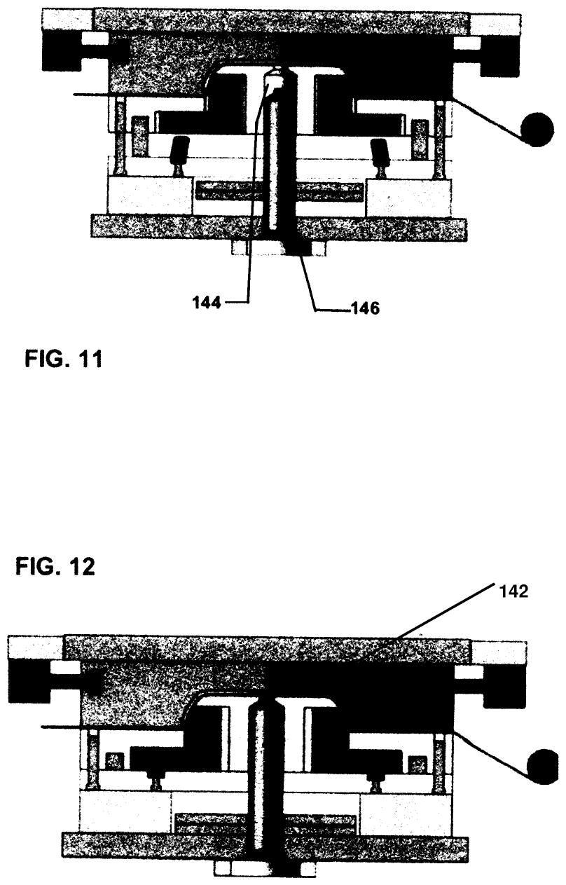

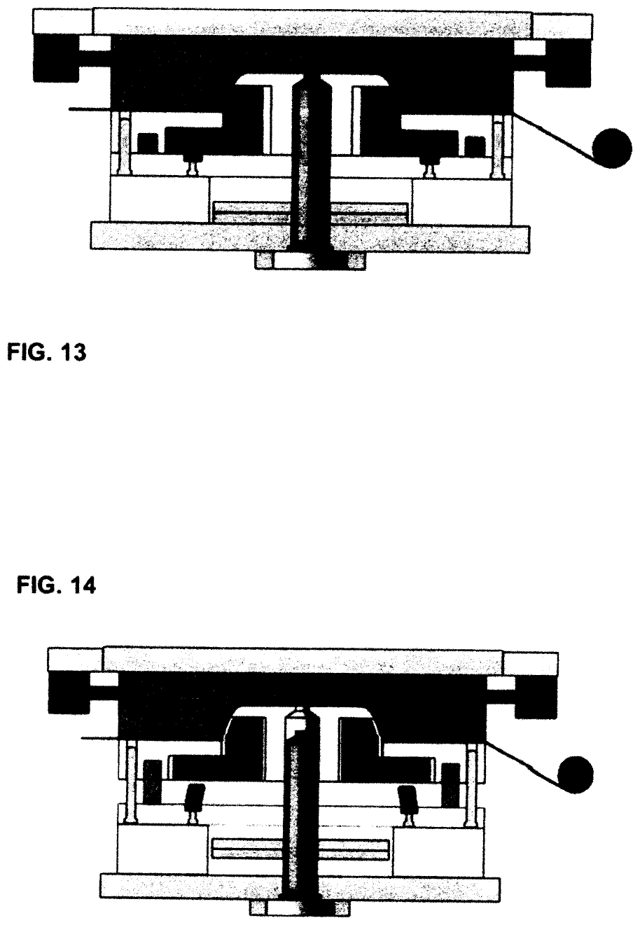

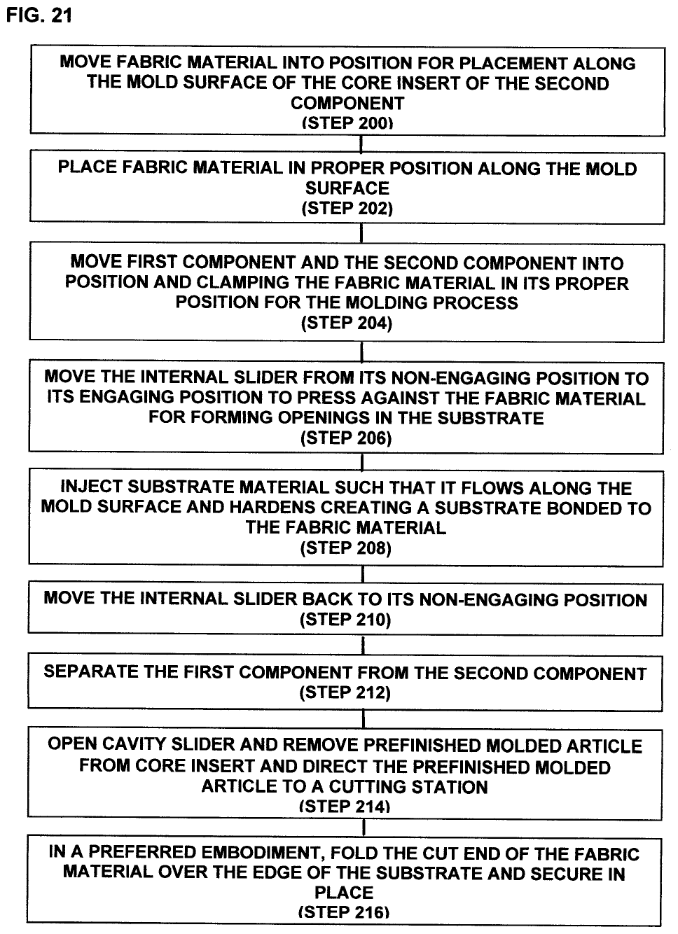

Referring to the Figures and particularly FIG. 21, in operation, fabric material 106 is moved into position for being placed between the contour portion 120 and the mold surface 128 (step 200) (FIG. 10). In a preferred embodiment, the fabric material 106 is precut to an appropriate size (slightly larger than the molded article to be formed). Once the fabric material 106 is in position between the contour portion 120 and the mold surface 128, it is held in position by the fabric positioning and maintaining system such that the one or more locator pins 136 are inserted in corresponding holes (not shown) in the fabric material 106 (step 202). After fabric material 106 has been placed in its proper position between the contour portion 120 and the mold surface 128, the first component 112 is moved towards the second component 114 such that the one or more cavity locator blocks 138 engage with the corresponding one or more core locator blocks 140 thereby pressing the fabric material 106 therebetween (such as shown in FIG. 11) and clamping the fabric material 106 in position and maintaining the fabric material 106 in its proper position during the molding process (step 204). As shown in FIGS. 11 and 12, after the fabric material 106 is in its proper position between the contour portion 120 and the mold surface 128, cam 132 is moved from a non-engaging position (FIG. 11) into an engaging position (FIG. 12) to engage the internal slider 130 and moves it into an activated position to press against the fabric material 106 (step 206). A suitable substrate material 142, such as a flowable plastic, is then injected through an injector channel 144 by an injector 146 such that the substrate material 142 flows along the mold surface 128 of the core insert 126 (FIG. 13) (between the fabric material and the mold surface) and then hardens thereby creating a substrate 104 which is bonded with the fabric material 106 forming a prefinished molded article 148 (step 208). It should be understood that the internal slider 130 is configured to press against the fabric material 106 creating spaces where the substrate material 142 is blocked from flowing thereby creating a desired number of openings or holes 134 in the substrate 104.

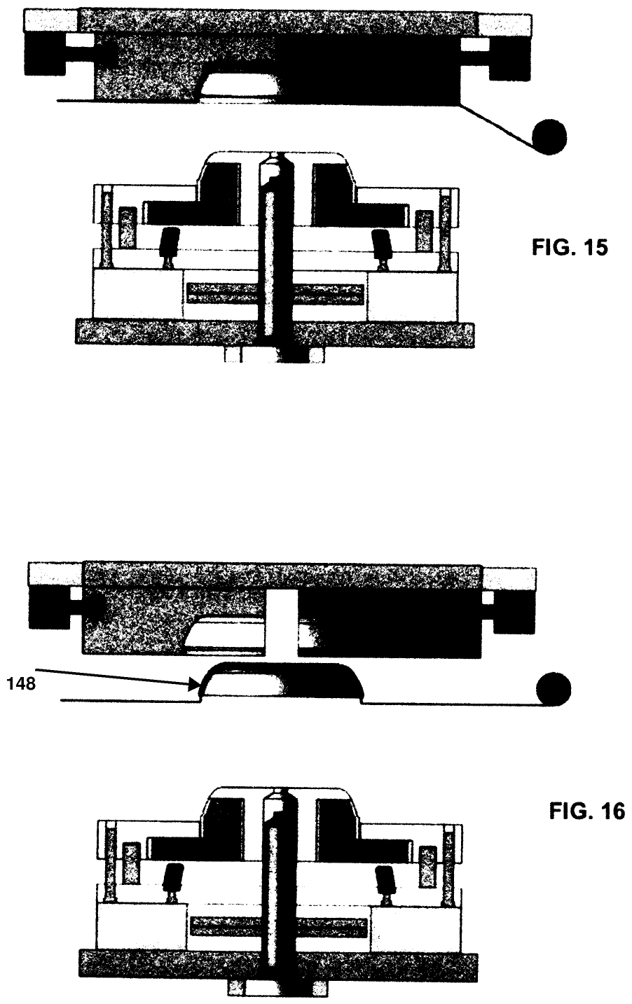

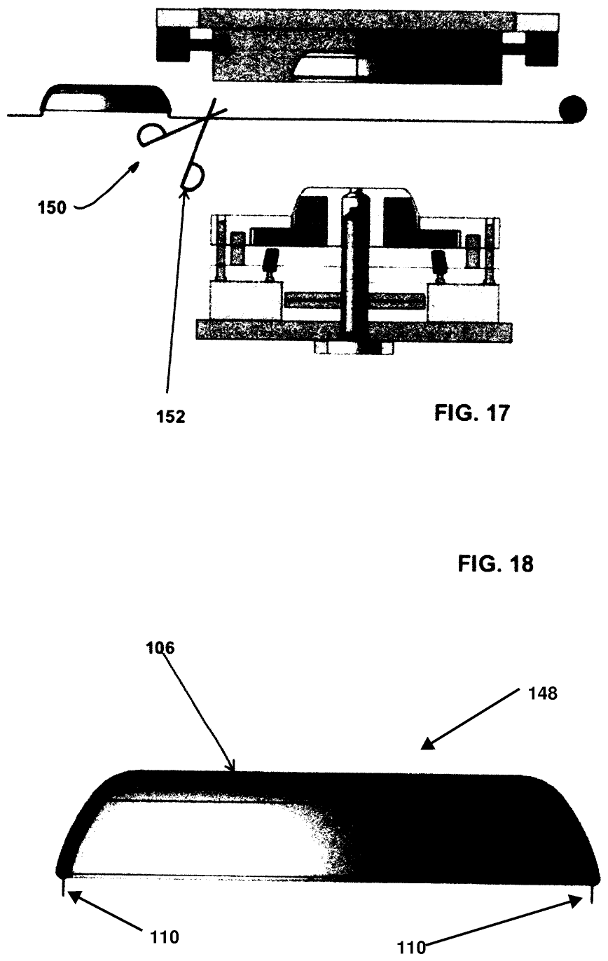

After the substrate material 142 has been injected along the mold surface 128 of the core insert 126 and has hardened, cam 132 operates to return back to its non-engaging position causing the internal slider 130 to retract back into its non-activated position (step 210). The first component 112 and the second component 114 then move away from each other (separates) leaving the prefinished molded article 148 (FIGS. 16-19) positioned along the mold contour portion 120 of the first component 112 (FIG. 15) (step 212). After separation of the first component 112 from the second component 114, the cavity slider 118 is moved from its closed position into its open position and the prefinished molded article 148 is removed from the core insert 126 (FIG. 16) where it is then directed to a cutting station 150 where the fabric material 106 is cut (FIG. 17) (step 214). After the prefinished molded article 148 has been removed from the first component 112, the cavity slider 118 returns to its closed position by the hydraulic system 122 and the molding process repeats. In a preferred embodiment, the fabric material 106 is pre-cut at a cutting station 150 is provided prior to positioning the fabric material 106 between the contour portion 120 and the mold surface 128 of the core insert 126. In another preferred embodiment, the molding system 102 includes a cutting tool 152 that operates as a die punch to provide a rough cut and extricate the molded article from the fabric roll after the molding process is completed. It should be understood that the cutting tool may be incorporated into an external slider or could be a separate tool component of the molding system. In another preferred embodiment, such as when the molding system of the subject invention is used in high velocity manufacturing operations, the fabric material is fed into the molding system in the form of a roll (such as shown).

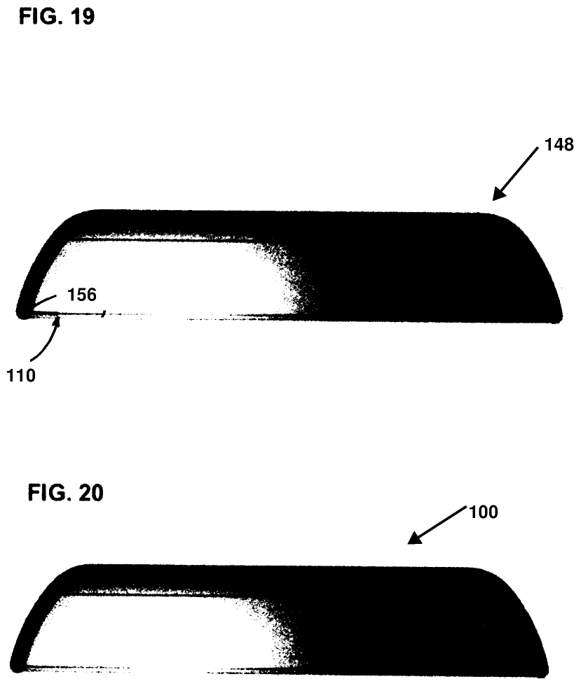

As illustrated in FIGS. 18-20, in a preferred embodiment after the prefinished molded article 148 is removed from the first component 112 and the fabric material 106 has been cut, the cut end of the fabric material 106 is folded to cover the edge 110 of the substrate 104 and secured in place, such as but not limited to a hot melt process (FIG. 19) (step 216) forming a final finished molded article 100 (FIG. 20). In another preferred embodiment, as shown in FIGS. 1 and 2, the molded article has a rib or flange 154 where the fabric material 106 is molded on the rib or flange and is then cut, such as by a laser or other cutting means, forming a final molded article 100 (FIG. 20) thereby eliminating the need for folding and attaching the fabric by separate processes. It should now be understood that the rib or flange 154 allows more accurate positioning of the molded article and provides more precise cutting of excess fabric material creating the final finished molded article. It should also now be understood that the cut end of the fabric material 106 folded over the edge 156 of the substrate 104, such as shown in FIGS. 19-20 provides a substrate/fabric end that is aesthetically better.

The prefinished molded article 148 formed by the system and method of the subject invention, as shown in FIGS. 1-2, the fabric material 106 positioned over the substrate 104 includes a plurality of openings 134 formed in the substrate 104 by the internal slider 130 during the molding process. It should be understood that by forming the openings during the molding process allows a plurality of openings to be formed in the substrate which are covered by the fabric material and eliminates the need of a separate cutting process to form such openings, reduces the likelihood of damaging the fabric material, and significantly reduces the time and cost associated by such a separate cutting process and/or repairing damage to the fabric material.

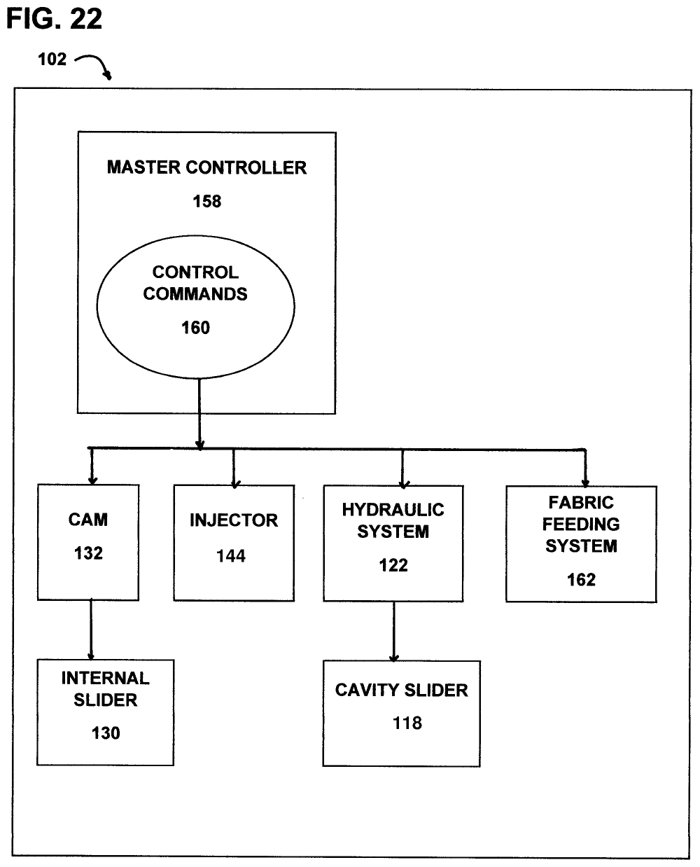

As previously stated, the various components of the molding system 102, such as cam 132, injector 144, hydraulic system 122, cutting tool 152, as well as systems for feeding fabric material in position for placement over the mold surface 128 and other systems for moving the first component and the second component towards and away from each other, each include conventional apparatus controls that function to perform a specific task of the molding process in a specific order. As schematically illustrated in FIG. 22, the molding system 102 is shown and preferably includes a master controller 158 that operates to continuously monitor the state of the manufacturing process, such as by utilizing a plurality of sensors, not shown. Preferably, the master controller 158 is a standard automation controller, such as a programmable logic controller (PLC) that operates using a high-level programming language to generate control commands 160 that are passed to the various apparatus controls operating in the molding system that are in electrical communication through a plurality of cables and wires, or through a wireless system. It should be understood that the master controller can also be a proportional-integral-derivative control system (PID), a distributed control system (DCS), or a computer, such as a general-purpose computer such as a personal computer (PC). It should be understood that the master controller includes input and output devices (collectively referred to as a human machine interface (HMI)), a memory 160, that together operate to provide instructions, using a machine code for the particular molding apparatus. It should be understood that more than one molding systems can operate sharing a single master controller, as shown in FIG. 22.

Various fabric material may be used to create the molded article of the subject invention, and has been found that both natural and synthetic fabric material such as those formed from cotton, polyamide, polyester or a combination thereof having fabric weighs between about 100 gr/m² to about 300 gr/m² with various elongation properties, preferably with elongation length of about 5% to about 25% and elongation width of about 10% to about 50% have been found suitable. The suitable substrate material forming can be various types of plastic. It has been found that acrylonitrile butadiene styrene (ABS) and polycarbonate (PC) are suitable plastic materials. In a preferred embodiment, the plastic material is colored to match the color of the fabric material.

It should now be apparent to one skilled in the art that the molded article formed from the molding system and process of the subject invention provides molded parts having a decorative outer surface or fabric or a film covered surface. As shown such parts may have one or more openings or apertures as desired. For example, articles or use with acoustical devices, such as speaker covers, where a plurality of openings are required to provide proper acoustical effects. Further, the molded articles of the subject invention have decorative surfaces formed by incorporating fabric or films along the surface of a molded article and does not require a second operation to be performed on the article after it has been removed from the mold to create holes along the surface of the molded article. This reducing both time consuming and decreases the manufacturing cost of the article.

It should be understood that in describing the preferred embodiments of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

1. A molding system for creating a molded article having a substrate and a fabric material positioned over the substrate, the molding system comprising:
a first component having a cavity slider with a contour portion;
a second component having a core insert with a mold surface;
wherein the molding system operates such that said core insert is moved into molding position with said contour portion and fabric material is positioned between said contour portion and said mold surface; and
wherein substrate material is injected along said mold surface between said mold surface and the fabric material to form a substrate for the fabric material.

2. The molding system of claim 1 wherein said second component further includes an internal slider that operates to move into to press the fabric material against said contour portion such that one or more openings are formed in the substrate.

3. The molding system of claim 1 wherein said second component includes a fabric positioning and maintaining system for maintaining the fabric material in place while substrate material is being injected along said mold surface.

4. The molding system of claim 1 wherein said second component includes one or more locator pins and core locator blocks and said first component includes cavity locator blocks, wherein said one or more locator pins, said core locator blocks and said cavity locator blocks cooperate to direct and maintain the fabric material in place while substrate material is being injected along said mold surface.

5. The molding system of claim 1 further comprising a cutting tool for cuffing the fabric material.

6. The molding system of claim 1 further comprising a master controller that operates to control the operation of the molding system.

7. A molding system for creating a molded article having a substrate and a fabric material positioned over the substrate, the molding system comprising:
a first component having a clamp plate supporting a cavity slider, wherein said cavity slider having a contour portion and wherein said cavity slider has a closed position and an open position, wherein said cavity slider is in said closed position when attaching the fabric material to the substrate forming a molded component and is in said open position when said molded component is removed from said molded component;
a second component having a clamp plate for supporting a core insert, said core insert having a mold surface and an internal slider that operates to move into and out of engagement with said mold surface; and
an injector and an injector channel for directing substrate material along said mold surface;
wherein said first component and said second component has a first position such that said first component and said second component are separated for receiving fabric material and has a second position such that the fabric material is positioned between said contour portion and said mold surface; and
wherein substrate material is injected into said injector surface such that the substrate material travels along said mold surface between said mold surface and the fabric material to form a substrate bonded to the fabric material.

8. The molding system of claim 7 wherein said second component further includes an internal slider that operates to move into to press the fabric material against said contour portion such that one or more openings are formed in the substrate.

9. The molding system of claim 7 wherein said second component includes a fabric positioning and maintaining system for maintaining the fabric material in place while substrate material is being injected along said mold surface.

10. The molding system of claim 7 wherein said second component includes one or more locator pins and core locator blocks and said first component includes cavity locator blocks, wherein said one or more locator pins, said core locator blocks and said cavity locator blocks cooperate to direct and maintain the fabric material in place while substrate material is being injected along said mold surface.

11. The molding system of claim 7 further comprising a cutting tool for cutting the fabric material.

12. The molding system of claim 7 further comprising a master controller that operates to control the operation of the molding system.

13. A process for making a molded article having a fabric material bonded to a substrate comprising the steps of:
moving fabric material into placement along a mold surface of a core insert of a second component;
moving a first component having a cavity slider with a contour portion such that the fabric material is between the contour portion and the mold surface;
moving an internal slider of the second component such that it is pressed against the surface of the fabric material;
injecting a substrate material such that it flows along the mold surface such that it forms a substrate bonded to the fabric material forming a prefinished molded article;
removing the prefinished molded article from placement along the mold surface; and
cutting the fabric material at the ends of the fabric material to form a finished molded article.

14. The process of claim 13 wherein the internal slider operates to prevent substrate material to flow along a portion of the mold surface thereby creating openings in the substrate.

15. The process of claim 13 wherein the substrate material has an outer edge and further comprising the step of folding the ends of the fabric material such that it covers the edge of the substrate.
